(19) United States
(12) Patent Application Publication
(10) Pub. No.: US 2024/0065469 A1
(43) Pub. Date: Feb. 29, 2024

(54) Beverage Infusion System with Removable Infusion Bed

(71) Applicants: Eugene J. Levin, Dover, MA (US); Aliaksandr Staliarou, Mogilev (BY)

(72) Inventors: Eugene J. Levin, Dover, MA (US); Aliaksandr Staliarou, Mogilev (BY)

(21) Appl. No.: 18/082,557

(22) Filed: Dec. 15, 2022

Related U.S. Application Data
(60) Provisional application No. 63/400,617, filed on Aug. 24, 2022.

(51) Int. Cl. A47J 31/20; A47J 31/00; A47J 31/06; B65D 3/06; B65D 85/808

(52) U.S. Cl. CPC A47J 31/20; A47J 31/005; A47J 31/06; B65D 3/06; B65D 85/808

(57) ABSTRACT

An infusion system, for use in making an infusion beverage, includes a a cup configured to hold liquid, the cup having an altitude from the lowermost position of liquid therein, the lowermost position defining a bottom of the cup. The system also includes an infusion component, for use in making the infusion beverage in the cup when liquid has been placed in the cup, the infusion component including a liquid permeable infusion bed configured to hold an infusion root, and dimensioned to rest in the bottom of the cup; and a removal strip having a first end attached to the infusion bed and a free second end. The removal strip is configured in relation to the infusion bed to facilitate grasping by a user of the free end of the removal strip by which the user can easily accomplish removal of the infusion component from the cup after making of the infusion beverage has been completed.

### RELATED APPLICATION

The present application claims the benefit of provisional application Ser. No. 63/400,617, filed Aug. 24, 2022, which is hereby incorporated herein by reference in its entirety.

### TECHNICAL FIELD

The present invention relates to infusion systems, and more particularly to beverage infusion systems having a removable infusion bed.

### BACKGROUND ART

Prior art infusion systems are disclosed in patent publications WO2010/020598, WO015/011689, EP0384106, and EP0158511.

### SUMMARY OF THE EMBODIMENTS

In accordance with one embodiment of the invention, there is provided an infusion component, for use in making an infusion beverage in a cup when liquid has been placed in the cup. In this embodiment, the infusion component includes:
a liquid permeable infusion bed configured to hold an infusion root; and
a removal strip having a first end attached to the infusion bed and a free second end, the removal strip configured in relation to the infusion bed to facilitate grasping, by a user, of the free end of the removal strip by which the user can easily accomplish removal of the infusion component from the cup after making of the infusion beverage has been completed.

In another embodiment, there is provided an infusion system for use in making an infusion beverage, and, in this embodiment the system includes:
a cup configured to hold liquid, the cup having an altitude from the lowermost position of liquid therein, the lowermost position defining a bottom of the cup;
an infusion component, for use in making the infusion beverage in the cup when liquid has been placed in the cup, the infusion component including
   a liquid permeable infusion bed configured to hold an infusion root, and dimensioned to rest in the bottom of the cup; and
   a removal strip having a first end attached to the infusion bed and a free second end, the removal strip configured in relation to the infusion bed to facilitate grasping by a user, of the free end of the removal strip by which the user can easily accomplish removal of the infusion component from the cup after making of the infusion beverage has been completed.

In a further related embodiment, the removal strip has a length not less than the altitude of the cup. Alternatively or in addition, the infusion bed is dimensioned in relation to a wall of the cup to provide a friction grasp of the infusion bed by the wall the cup. In another related embodiment, the bottom of the cup is circular and the infusion bed has a circular base, and the first end of the strip has a set of fingers attached to the base, the set of fingers being arranged in a manner to subtend an arcuate distance around the base of more than 180 degrees.

In a further related embodiment, the infusion bed is cylindrical in shape. Alternatively, the infusion bed has a non-circular shape and is configured to provide an exposed surface area, per unit of volume, that is greater than the surface area of a similarly dimensioned cylinder. In yet another related embodiment, the infusion bed has a pyramidal shape. In a further related embodiment, the system is packaged with the infusion component disposed in the cup to support immediate use of the system in making of the infusion beverage.

### BRIEF DESCRIPTION OF THE DRAWINGS

The foregoing features of embodiments will be more readily understood by reference to the following detailed description, taken with reference to the accompanying drawings, in which:

FIG. 1 is a cut-away view of an infusion system in accordance with an embodiment of the present invention;

FIGS. 2A, 2B, 2C, 2D, and 2E are perspective views of an infusion component in accordance with embodiments of the invention, including, in each instance, a liquid permeable infusion bed with an attached removal strip, configured to facilitate easy removal of the infusion component from its associated cup after brewing of an infusion;

FIGS. 3A, 3B, 3C, and 3D are representations of the tip of each of four distinct removal strips of infusion components, in accordance with embodiments of the present invention, used to remove its corresponding infusion bed from a cup after brewing of an infusion;

FIG. 4 is a cut-away view of an infusion system, in accordance with an embodiment of the present invention, in which the infusion component has been partially removed from the cup after brewing of an infusion; and

FIG. 5 is perspective view of a stack of infusion systems, in accordance with an embodiment of the present invention, each infusion system including a cup, an infusion component, disposed in the cup, including an infusion bed and a removal strip coupled to the infusion bed and disposed along an inside wall of the cup.

### DETAILED DESCRIPTION OF SPECIFIC EMBODIMENTS

Definitions. As used in this description and the accompanying claims, the following terms shall have the meanings indicated, unless the context otherwise requires:

A “set” includes at least one member.

An “infusion root” is an item, such as tea leaves or instant coffee, that can be used to make an infusion.

An “infusion” is a liquid beverage or soup made by infusing an infusion root (as defined herein) with a liquid such as water or milk.

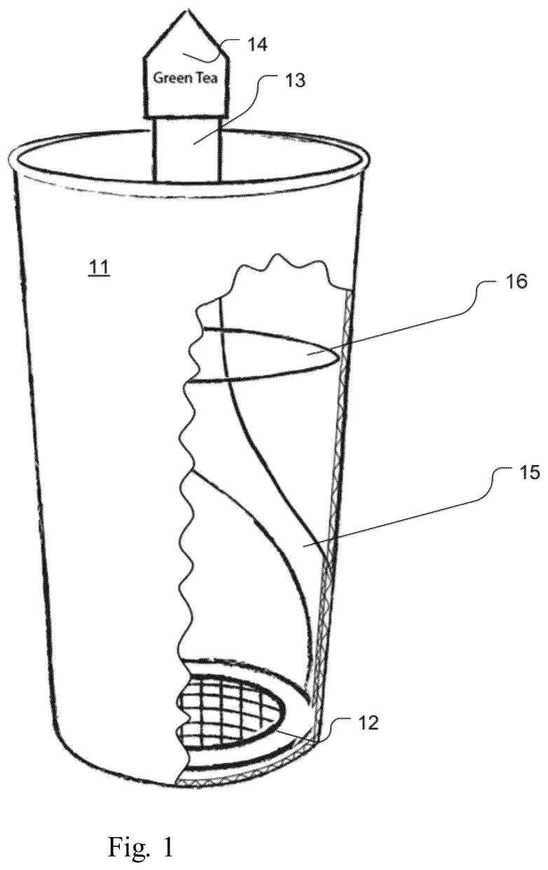

FIG. 1 is a cut-away view of an infusion system in accordance with an embodiment of the present invention. In this embodiment the cup 11 includes an infusion system formed by water-permeable infusion bed 12, to which is attached strip 13 to facilitate easy removal of the infusion bed 12 from the cup 11 after the infusion has been brewed. The infusion bed has a circular shape to conform to the circular shape of the bottom of the cup. In various embodiments, the infusion bed has a diameter sufficient large as to fit snugly into the base of the cup. The strip 13 has, at its tip, a label 14 to identify the type of infusion root that is provided in the infusion bed, so that the user can determine what will be fused when hot water is added to the cup 11. In this particular embodiment, the infusion root is marked as “green tea.” The strip 13 is configured in this embodiment with a pair of fingers 15, of which one finger is shown in FIG. 1. The set of fingers is arranged in a manner to subtend an arcuate distance around the infusion bed of approximately 180 degrees, so that forces applied to the tip of the strip to remove the infusion bed from the cup are distributed to a pair opposing sides of the infusion bed by the fingers 15 in a manner to facilitate removal of the infusion bed which maintain the infusion bed in an approximately horizontal orientation. The infusion system of FIG. 1 is used by adding piping hot water to the cup 11. When added, the hot water enters the water-permeable infusion bed 12 and mixes with the infusion root that has been placed in the infusion bed 12. The mixing of the hot water with the infusion root produces the infusion beverage or soup 16, as the case may be, depending on the composition of the infusion root. The resulting infusion 16 can be accessed by the user directly from the cup 11.

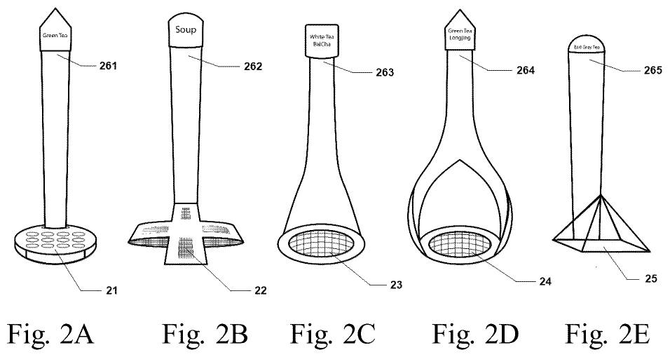

FIGS. 2A, 2B, 2C, 2D, and 2E are perspective views of various embodiments of various liquid permeable infusion beds with associated strips to enable, in each case, the infusion bed to be easily removed from a cup after brewing of an infusion. In FIG. 2A, the infusion bed 21 is has a circular base and has a circumference conforming to the shape of the bottom of cup 11 so as to occupy substantially the entirety of the bottom of the cup 11 in a manner similar to the infusion bed 12 of FIG. 1. The strip 261 of FIG. 2A is a straight strip coupled to the infusion bed 21. In FIG. 2B, the infusion bed 22 has a shape corresponding a “plus” sign (+); this shape has the benefit of exposing directly to water (when added) a greater surface area of the root in the infusion bed than in the case of the infusion bed 21 of FIG. 2A. The strip 262 of FIG. 2B is straight in a manner similar to strip 261, but has a rounded tip. In FIGS. 2C and 2D, the infusion beds 23 and 24 respectively have the same circular shape as the infusion bed 21 of FIG. 2A. On the other hand, the strip 263 of FIG. 2C is wide at its base so as to subtend nearly 180 degrees of arcuate distance around the infusion bed 23. The strip 264 of FIG. 2D has a pair of fingers similarly subtending about 180 degrees of arcuate distance around the infusion bed 24. In FIG. 2E the infusion bed 25 has a pyramidal shape, which also has the effect of exposing to added water a larger surface area of the root than does the cylindrical infusion bed 21 of FIG. 2A. In FIG. 2E, the strip 265 is straight, like the strip 262 of FIG. 2B, for example.

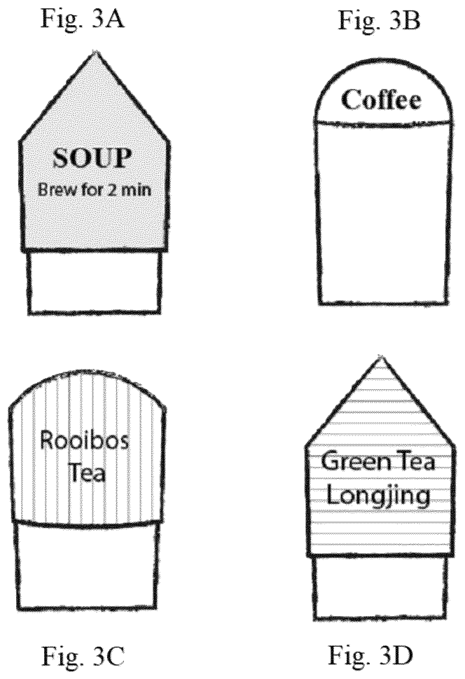

FIGS. 3A, 3B, 3C, and 3D are representations of the tip of each of four distinct strips used to remove its corresponding infusion bed from a cup after brewing of an infusion. In FIG. 3A, the tip is labeled for “SOUP” when the corresponding root is configured to make soup, whereas in FIGS. 3B, 3C, and 3D, the tips are respectively labeled for coffee, rooibos tea, and green tea longing, according to the corresponding root. As indicated in these figures, the shape of the tip can also be varied in accordance with the corresponding root included in the infusion bed.

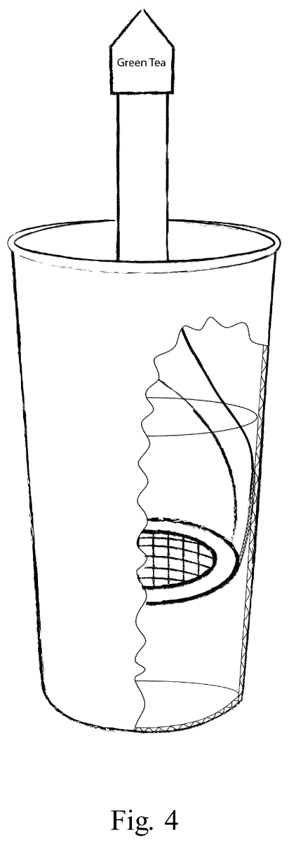

FIG. 4 is a cut-away view of the infusion system of FIG. 1, in accordance with an embodiment of the present invention, in which the infusion bed 12 has been partially removed from the cup 11 after brewing of an infusion by pulling on the strip 13. Because the embodiment of the infusion system of FIG. 1 utilizes a pair of fingers subtending about 180 degrees of arcuate distance around the infusion bed 12, pulling on the strip 13 has the effect of maintaining the general orientation of the infusion bed 12 (namely horizontal) in the cup even when the infusion bed is being removed.

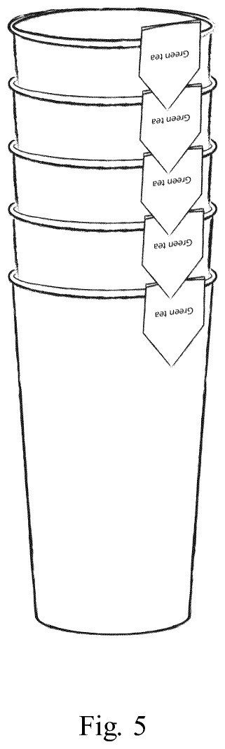

FIG. 5 is perspective view of a stack of infusion systems, in accordance with an embodiment of the present invention, each infusion system including a cup, an infusion bed disposed in the cup, and a strip coupled to the infusion bed and disposed along an inside wall of the cup. The infusion system of this embodiment is configured for convenience in stacking.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. An infusion component, for use in making an infusion beverage in a cup when liquid has been placed in the cup, the infusion component comprising;
a liquid permeable infusion bed configured to hold an infusion root; and
a removal strip having a first end attached to the infusion bed and a free second end, the removal strip configured in relation to the infusion bed to facilitate grasping, by a user, of the free end of the removal strip by which the user can easily accomplish removal of the infusion component from the cup after making of the infusion beverage has been completed.

2. An infusion system for use in making an infusion beverage, the system comprising;
a cup configured to hold liquid, the cup having an altitude from the lowermost position of liquid therein, the lowermost position defining a bottom of the cup;
an infusion component, for use in making the infusion beverage in the cup when liquid has been placed in the cup, the infusion component including
a liquid permeable infusion bed configured to hold an infusion root, and dimensioned to rest in the bottom of the cup; and
a removal strip having a first end attached to the infusion bed and a free second end, the removal strip configured in relation to the infusion bed to facilitate grasping by a user, of the free end of the removal strip by which the user can easily accomplish removal of the infusion component from the cup after making of the infusion beverage has been completed.

3. An infusion system according to claim 2, wherein the removal strip has a length not less than the altitude of the cup.

4. An infusion system according to claim 2, wherein the infusion bed is dimensioned in relation to a wall of the cup to provide a friction grasp of the infusion bed by the wall the cup.

5. An infusion system according to claim 2, wherein the bottom of the cup is circular and the infusion bed has a circular base, and the first end of the strip has a set of fingers attached to the base, the set of fingers being arranged in a manner to subtend an arcuate distance around the base of approximately 180 degrees.

6. An infusion system according to claim 5, wherein the infusion bed is cylindrical in shape.

7. An infusion system according to claim 1, wherein the infusion bed has a non-circular shape and is configured to provide an exposed surface area, per unit of volume, that is greater than the surface area of a similarly dimensioned cylinder.

8. An infusion system according to claim 7, wherein the infusion bed has a pyramidal shape.

9. An infusion system according to claim 1, wherein the system is packaged with the infusion component disposed in the cup to support immediate use of the system in making of the infusion beverage.
